(19) United States
(12) Patent Application Publication
(10) Pub. No.: US 2013/0321701 A1
(43) Pub. Date: Dec. 5, 2013

(54) METHOD, DEVICE, COMPUTER PROGRAM AND INFORMATION STORAGE MEANS FOR TRANSMITTING A SOURCE FRAME INTO A VIDEO DISPLAY SYSTEM

(71) Applicant: CANON KABUSHIKI KAISHA, Tokyo (JP)

(72) Inventors: TRISTAN HALNA DU FRETAY, LANGAN (FR); Hirohiko Inohiza, RENNES (FR)

(73) Assignee: CANON KABUSHIKI KAISHA, Tokyo (JP)

(21) Appl. No.: 13/905,030

(22) Filed: May 29, 2013

(30) Foreign Application Priority Data
May 31, 2012 (GB) 1209683.0

(51) Int. Cl. H04N 5/04

(52) U.S. Cl. CPC H04N 5/04
USPC 348/512

(57) ABSTRACT

Method, device, computer program and information storage means for transmitting a source frame into a video display system, the video display system (10) comprising a plurality of projectors, the video display system (10) further arranged to produce a projected image (106) from the source frame (100), each projector (102, 103, 104, 105) arranged to display a sub-frame (106A, 106B, 106C, 106D) of the projected image (106). The video display system further comprises capability to arrange a display delay, equal to a delay between reception of a source frame synchronization signal and a sub-frame display synchronization signal, dependent on the positions and the orientations of the video projectors, such that display of the projected image begins before at least one projector has received an associated complete sub-frame.

This application claims priority under 35 U.S.C. §119(a)-(d) of United Kingdom Patent Application No. 1209683.0, filed on May 31, 2012 and entitled “Method, device, computer program and information storage means for transmitting a source frame into a video display system”. The above cited patent application is incorporated herein by reference in its entirety.

### FIELD OF THE INVENTION

The invention relates to the field of video display systems, more particularly to multi projector video systems.

The invention further relates to the transmission of a source frame into such a system and the division and processing of the source frame by the system.

### BACKGROUND OF INVENTION

The present invention relates to a video display system, comprising a multi projector (MP) arrangement, capable of distributing sub-frames of images between a plurality of VP (video projectors).

Consider a video projection system comprising multiple projectors arranged to generate adjacent, partially overlapping, images on a projection screen. The goal is to display high-definition (HD) video offering the user high image quality. Each individual video projector generates an image with a given definition and a size determined by the projector lens focal length, the size of the projector's light modulation device (e.g. an LCD panel) and the distance between the projector and the screen. Increasing the projection distance yields a larger, but also darker, image since the brightness decreases with the square of the distance. Covering a very large projection screen with a sufficient definition and brightness usually requires aggregating several video projectors in a manner that they cover adjacent, partially overlapping, zones of the total screen area. In the overlapping zones, a technique known as blending ensures a smooth transition between adjacent projectors in a manner that can accommodate small displacements introduced e.g. by vibrations or thermal expansion. Blending consists of continuously decreasing the brightness of the image generated by one projector towards the border of the zone covered by said projector and, complementarily, increasing the image brightness by the adjacent projector in a manner so as to obtain uniform brightness after superposition. Such a technique is well known and is described in the prior art.

Patent application US 2011/0019108 discloses how to extract sub-frames illuminated by each projector, overlay areas of illumination and define blending parameters. The partitioning and blending of the image to be projected by a multi-projector system has to be carefully adjusted to give the user the impression of a perfectly matching, continuous image over the whole screen area. Such a calibration process is typically carried out during system installation, or during power-up, and generally requires some user interaction, e.g. taking digital calibration photos of the screen.

Each VP (video projector) in the system displays a sub-image of the overall video image to be displayed by the complete MP (multi projection) system.

In order to make the system easy to install and rearrange, or to make it look sleeker, communication and data transfer between video projectors are done using a synchronous wireless network (i.e. network elements share a common network clock). This kind of network is well adapted to constant bandwidth transfers, such as video and audio. The system can be designed towards display of uncompressed high quality video and an associated wireless network normally uses a 60 GHz frequency band, in order to provide the required bandwidth.

With an aim of matching as many video formats and video frame ratios as possible, each video projector of the system may be rotated in various orientations, according to the screen size, image shape, mounting environment . . . etc. This results in a situation where all the projectors constituting the system do not have the same orientation. Some might be horizontal (projecting an image in landscape orientation), while some others might be vertical (projecting an image in portrait orientation).

For video display, a video frame is conventionally displayed line by line, from the top to the bottom, in landscape mode (i.e. long side of the frame is horizontal). The instant corresponding to the beginning of a video frame display process is marked by a signal called Vertical Synchronization (Vsync) signal.

When using a multi-projector, i.e. multi-display, video projection system, each video projector is in charge of displaying a sub-frame of the global frame of the image to display. It is important that the display of all sub-frames, associated with all video projectors in the system, are well synchronized, in order to avoid visual artifacts. This means that Vsync signals marking the beginning of a sub-frame display on each slave video projector are arranged to occur simultaneously.

Patent application US2005/0174482 A1 describes an example of the synchronization of multiple video output data in a multi display system. In particular, the document describes a multi-screen video reproducing system capable of performing synchronized video reproduction for a long time by using a simple system without recognizing an absolute time. The multi-screen video reproducing system comprises a LAN (local area network) functioning as a network.

In classical multi-projection systems, the device in charge of splitting and distributing the video sub-frame data (e.g. the master projector) buffers the full video frame. Then it splits it into sub-frames and distributes it line by line to the corresponding display. This device also distributes synchronization signals. Display devices (e.g. the slave projectors) receive data line by line and display them, in accordance with the synchronization signals.

As the full source video frame is stored before processing, this classical method generates a latency corresponding to a full frame buffering time, before starting to feed video line data to the video projectors. This latency may be critical for a real time application such as video gaming, flight simulator, etc. and comprises a problem of the video display system.

### SUMMARY OF INVENTION

The invention sets out to address the problem of latency, while keeping a correct synchronization between all video projectors constituting the video projection system.

According to a first aspect, this is achieved by provision of a method of transmitting a source frame into a video display system comprising a plurality of projectors, the video display system further arranged to produce a projected image from the source frame, each projector arranged to display a sub-frame of the projected image,

the method, comprising the steps of:
determining a position and/or an orientation for each projector;
calculating a display delay representative of a delay between reception of a source frame synchronization signal and a sub-frame display synchronization signal, dependent on the positions and the orientations, such that display of the projected image begins before at least one projector has received an associated complete sub-frame;
applying the display delay between the source frame synchronization signal and a sub-frame display synchronization signal, and;
synchronizing projectors sub-frame display synchronization signals with the sub-frame display synchronization signal.

The proposed invention comprises the determination of an optimized latency between the beginning of a source video frame and the beginning of sub-frame display by projectors comprised in the system. This optimized latency determination is based on the orientation and position of the projectors, as some configurations (for instance, if all projectors displaying the bottom edge of a global frame from the video source are set in landscape position) allow the start of a frame display before all video data has been received by the video projectors.

A main advantage to this method is removal of superfluous latency between the video source data delivery from the video source device and the display of those data on the screen: the latency is optimized, the optimization taking account of the multi-projection system configuration. At the same time, a tight and correct synchronization is kept between all projector displays, thereby avoiding visual artifacts.

In a further embodiment of the invention, the plurality of projectors comprises a master projector and a plurality of slave projectors, the master projector being arranged to implement the steps of the method.

A (master) projector can be arranged to be in charge of global source video data reception and video sub-frame distribution to other projectors and also host functions to split, rotate and store video frame sub-frame data. It should be noted, however, that these functions may also be hosted in e.g. the source device.

In a further embodiment of the invention, the method further comprises the step of:
adapting a buffering for each projector according to the position and the orientation for each projector, and according to the display delay.

Buffering means are determined according to the optimized latency. Video synchronization signals, used to drive the beginning of frame display on the projectors, are generated, so that a time interval equal to the optimal latency is maintained between video source synchronization signals and projectors video synchronization signals.

An advantage to this method is that a sub-frame rotation process, when needed, is done on the fly during video data reception. Thus, this processing does not generate extra latency.

In a further embodiment of the invention, the buffering comprises
FIFO for a landscape up-right projector;
and, Ping-Pong full frame memory for any other orientation.

With such a method, the buffering need is optimized.

In a further embodiment of the invention, the method further comprises the step of:
requesting a projector to flip the display of its associated sub-frame if the orientation is determined as upside-down.

This embodiment of the invention takes advantage of projector video flip capacity to optimize end to end display latency.

In a further embodiment of the invention, the method further comprises the step of:
minimizing the display delay.

In a further embodiment of the invention, the method further comprises the step of:
receiving of the source frame by the master projector.

In a further embodiment of the invention, the method further comprises the step of:
distributing sub-frames to the slave projectors for display by the master projector.

In another aspect of the invention, there is provided a method of operating a video display system comprising a plurality of projectors, the video display system further arranged to cooperate with a video source to produce a projected image from a source frame, each projector arranged to display a sub-frame of the projected image comprising lines,

the method comprising the steps of:
checking for a landscape orientation, for each of the projectors associated with a bottom border of the projected image;
defining a start-of-display parameter as a line associated with the sub-frames comprising the bottom border of the projected image, the line comprising the line immediately following the lowest horizontal overlapping area between said sub-frames and sub-frames located immediately above, and;
determining a display delay for the projected image based on the start-of-display parameter, such that display of the projected image is suspended until data associated with the sub-frames of the bottom border of the projected image in advance of the start-of-display parameter are placed in a buffer.

In another aspect of the invention, there is provided a method of operating a video display system comprising a plurality of projectors, the video display system further arranged to cooperate with a video source to produce a projected image from a source frame, each projector arranged to display a sub-frame of the projected image comprising lines,

the method comprising the steps of:
checking for a landscape orientation, for each of the projectors associated with a bottom border of the projected image;
checking for a landscape orientation, for each of the projectors associated with a portion of the projected image located immediately above the bottom border of the projected image;
defining a start-of-display parameter as a first pixel line of the lowest sub-frame if the sub-frames located immediately above the lowest sub-frames are all in landscape orientation, and;
determining a display delay for the projected image based on the start-of-display parameter, such that display of the projected image is suspended until data associated with the lowest sub-frames above the bottom border and above the start-of-display parameter are available from the video source.

In a further embodiment of the invention, the plurality of projectors comprises a master projector (102) and a plurality of slave projectors (103, 104, 105), the master projector being arranged to implement the steps of the method.

In a further embodiment of the invention, the method further comprises the step of:
checking for an upright positioning (502), for each of the projectors associated with the bottom border of the projected image (106).

In a further embodiment of the invention, the method further comprises the step of:
determining buffering means (505) based on the start-of-display parameter, for each of the projectors associated with a bottom border (106C, 106D) of the projected image (106).

In another aspect of the invention, there is provided a computer program comprising instructions for carrying out each step of the method according to any embodiment of any previous aspect of the invention when the program is loaded and executed by a programmable apparatus.

In another aspect of the invention, there is provided an information storage means readable by a computer or a microprocessor storing instructions of a computer program, wherein it makes it possible to implement the method according to any embodiment of any previous aspect of the invention.

In another aspect of the invention, there is provided a device for transmitting a source frame into a video display system comprising a plurality of projectors, the video display system further arranged to produce a projected image from the source frame, each projector arranged to display a sub-frame of the projected image, the device comprising:
means for determining a position and/or an orientation for each projector;
means for calculating a display delay representative of a delay between reception of a source frame synchronization signal and a sub-frame display synchronization signal, dependent on the positions and the orientations, such that display of the projected image begins before at least one slave projector has received an associated complete sub-frame;
means for applying the display delay between the source frame synchronization signal and a master projector sub-frame synchronization signal;
means for synchronizing slave projectors sub-frame display synchronization signals with the master projector sub-frame synchronization signal.

The proposed invention comprises the determination of an optimized latency between the beginning of a source video frame and the beginning of sub-frame display by projectors comprised in the system. This optimized latency determination is based on the orientation and position of the projectors, as some configurations (for instance, if all projectors displaying the bottom edge of a global frame from the video source are set in landscape position) allow the start of a frame display before all video data has been received by the video projectors.

A main advantage to this method is removal of superfluous latency between the video source data delivery from the video source device and the display of those data on the screen: the latency is optimized, the optimization taking account of the multi-projection system configuration. At the same time, a tight and correct synchronization is kept between all projector displays, thereby avoiding visual artifacts.

In a further embodiment of the invention the device further comprises:
means for adapting a buffering for each projector according to the position and the orientation for each projector, and according to the display delay.

Buffering means are determined according to the optimized latency. Video synchronization signals, used to drive the beginning of frame display on the projectors, are generated, so that a time interval equal to the optimal latency is maintained between video source synchronization signals and projectors video synchronization signals.

An advantage to this method is that a sub-frame rotation process, when needed, is done on the fly during video data reception. Thus, this processing does not generate extra latency.

In a further embodiment of the invention the device further comprises:
means for requesting a projector to flip the display of its associated sub-frame if the orientation is determined as upside-down.

In a further embodiment of the invention the device further comprises:
means for minimizing the display delay.

This embodiment of the invention takes advantage of projector video flip capacity to optimize end to end display latency.

In a further embodiment of the invention, the plurality of projectors comprises a master projector and a plurality of slave projectors.

### BRIEF DESCRIPTION OF THE FIGURES

FIG. 1 illustrates a wireless multi-projection video system capable of implementing embodiments of the current invention.

FIG. 2a illustrates timings of control signals which facilitate the synchronous display of video in a multi-projector system, according to common practice.

FIG. 2b illustrates timings of control signals which facilitate the synchronous display of video in a multi-projector system, according to an embodiment of the invention.

FIG. 3 illustrates a multi-projection system configuration capable of implementing a latency optimization according to an embodiment of the invention.

FIG. 4 illustrates a method of system initialization according to an embodiment of the invention.

FIG. 5 illustrates a method of display_delay determination according to an embodiment of the invention.

FIG. 6 illustrates a method of buffering means determination according to an embodiment of the invention.

FIG. 7 illustrates a method of storage mode setting according to an embodiment of the invention.

FIG. 8 illustrates frame sub-areas extraction, according to an embodiment of the present invention.

FIG. 9, parts a and b, illustrates methods of system synchronization for the master projector and slave projectors, respectively, according to an embodiment of the current invention.

FIG. 10, parts a and b, illustrates frame display according to an embodiment of the current invention. Part a relates to storage mode equal to mode 1 and part b to storage modes 2, 3 and 4.

FIG. 11 illustrates an optional method according to an embodiment of the current invention implemented on a slave video projector if it receives a flip request.

FIG. 12 illustrates a schematic functional block diagram of a video projector capable of implementing an embodiment of the current invention.

### DETAILED DESCRIPTION OF THE INVENTION

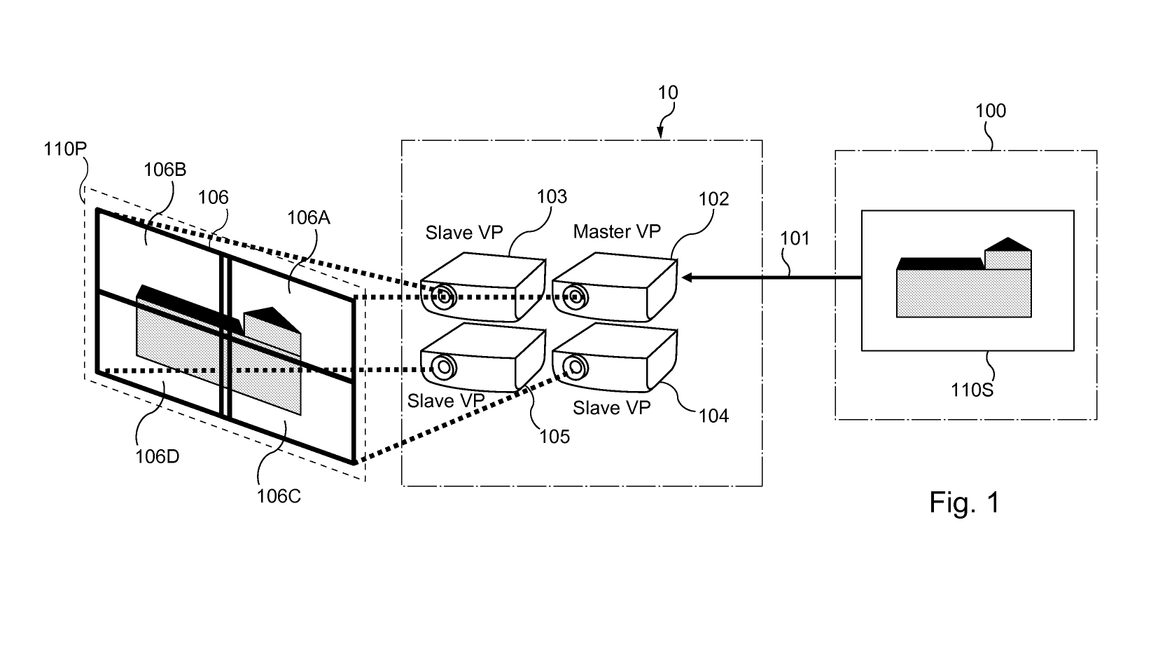

FIG. 1 shows an example of a wireless multi-projection video system 10 capable of implementing one or more embodiments of the current invention. The video system is illustrated as a wireless system, but the invention can equally be implemented on a system with a wired connection for data transfer from a source device. The video system 10 comprises a plurality of communication and display devices 102, 103, 104 and 105 embodied in video projectors. The video projectors further comprise a master projector 102 arranged in cooperation with a plurality of slave projectors 103, 104 and 105.

Using such a system, the user is able to manage the display of high quality video (for example 4k2k video: with an associated size image comprising 3840×2160 pixels) on a large area with standard video projector devices (able to support 1080p HD video 1920×1080 pixels).

In the exemplary system described, video input (4k2k video) is provided by a video source device 100 to one video projector of the system. This video projector, referred to as the master video projector 102, is able to manage the cutting of video, e.g. comprising a global source frame 110S, into four 1080p HD streams or sub-frames, and the creating of a blending area, comprising an overlapping area, in order to compensate chrominance and luminance between the video projectors102, 103, 104 and 105. The master projector 102 is also in charge of video display synchronization signal generation and distribution to slave projectors. (Alternatively, all or part of the cutting, synchronization or distribution functions of the master projector 102 can be implemented in the source device 100). This results in a final display which appears as if issued from a single projector. The video source 100 is connected to master video projector 102 of the multi-projector system through connection 101, either through a wired HDMI connection, or through a specific wireless connection able to sustain the high bit data rate of video without degradation.

In the multi-projection video system 10, connections between projectors are based on wireless technology, such as 60 GHz able to provide several Gbps (Giga bits per second) data throughput that may be used for video exchange without need of compression technology. As an alternative embodiment, connections between projectors are based on wired technology.

In the exemplary multi-projection video system 10, an image capture device (such as a camera, not represented) is connected in a preferred mode through a wired connection to a video projector, preferably the master video projector, and enables the capture of the full display projection area 106. In another embodiment, this connection could also be achieved through wireless radio means to one of the video projector of the system.

In such a multi-projection video system 10, each video projector 102, 103, 104 and 105 is in charge of projecting a sub-frame 106A, 106B, 106C, 106D, respectively, of the global source frame 110S, and the aggregation of all those sub frame projections is the global frame projection 110P.

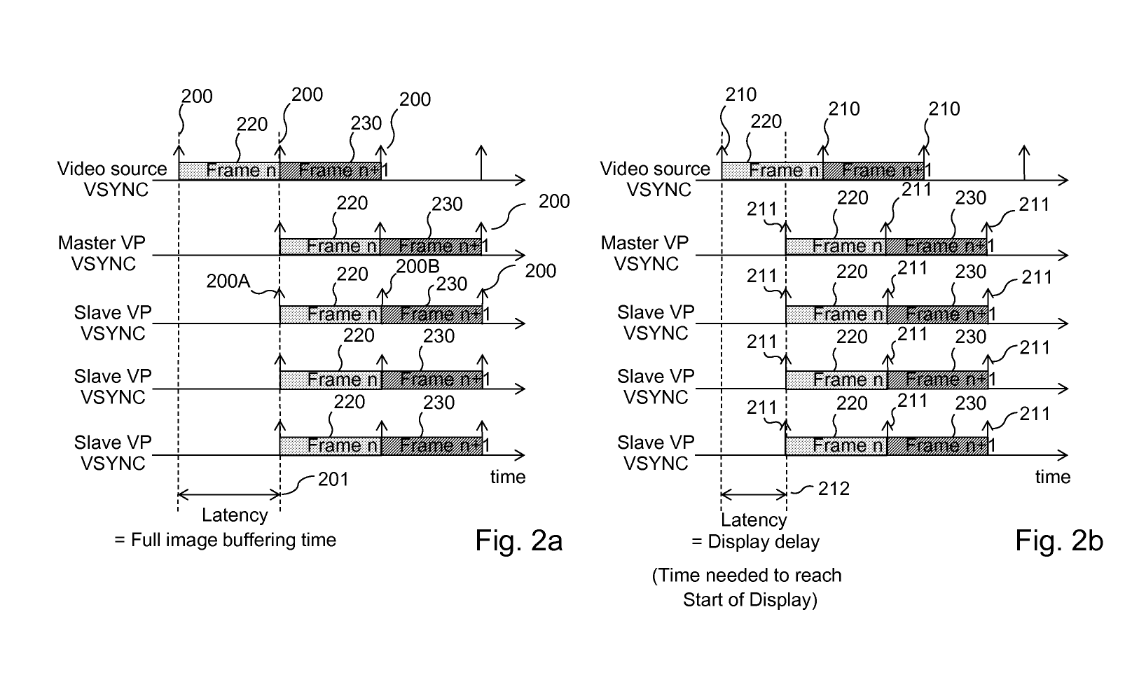

FIG. 2 parts a and b illustrate the timings of control signals which facilitate the synchronous display of video, (a) according to common practice and (b) according to an embodiment of the invention.

A video source device 100 provides a global video frame data 110S line by line, starting from the top left of the source frame.

The video projector displays frames by means of a LCD (liquid crystal display) grid, crossed by light coming from a powerful lamp, each intersection of the grid being arranged to represent a pixel. This LCD grid is always in landscape orientation (i.e. when the video projector is set up right on a table, the picture it displays is broader than its height), and video data is set in the LCD grid line by line.

If a video projector has to display a global frame sub-part in landscape orientation, lines in the global frame correspond to lines in the video projector LCD grid, thus the LCD grid can be filled with video data in the same order as this video data is provided to the video projector, and thus a display process of the frame sub-part can start as soon as video data is provided to the video projector.

In the case of a projector (most often a slave projector) set in portrait mode, lines of the global frame correspond to columns of the video projector LCD (as the video projector, and thus the LCD grid, has been rotated by 90 or 270 degree with respect to the lens axis). All lines of the global frame sub-frame corresponding to the rotated video projector (i.e. all lines of the sub-frame the video projector has to display) have to be provided to the video projector before a line of the video projector LCD grid can be completed. This means that a video projector in portrait orientation has to receive and store (in a buffer) the full video data of the frame sub-frame it has to display before actually starting to display it (i.e. filling data in its LCD grid).

Such a situation illustrates that if any video projector, allocated to display the lowest parts of the global frame, is in portrait orientation, then the last data of the global frame (bottom right corner) need to be received before starting the display process. As all video projectors have to start displaying sub-frames corresponding to a same global frame at same time to avoid visual artifacts, this means that the full global frame data has to be received from the source and stored before being processed. This corresponds to a full frame latency (i.e. a frame is being received from the video source, while the previous frame is being displayed).

FIG. 2a illustrates a full frame latency situation and the associated timings. As described in video standards specifications (such as the HDMI 1.4 standard), video frame data presentation is driven by a set of synchronization signals (or clocks). In the specifications, there is provided a vertical synchronization signal, here referred to as Vsync, which marks each new frame start (see HDMI standard). Video source and video projector are all following the same synchronization signal Vsync 200. During two subsequent occurrences of Vsync 200A and 200B, as viewed by a slave video projector, the video source is delivering global video frame data n+1 230, while the video projectors are displaying video frame sub-part data corresponding to global video frame n 220. Thus latency between a global frame delivery by the source and its actual display corresponds to the duration of a global frame (16 ms if video is 60 frames per seconds). In other words, the latency as indicated 201 equals the full image buffering time.

Conversely, as illustrated in FIG. 2b, if all video projectors in charge of displaying the lowest sub-frames of the global frame (i.e. sub-parts comprising the global frame bottom border) are in landscape orientation, then all video projectors (VP) can start to display their respective sub-frames as soon as the following conditions are fulfilled:
all lowest video projectors receive their first data, and
all video projectors in portrait orientation located above the lowest VP have received all data corresponding to their allocated sub-frame (no such condition for VP in landscape orientation located above the lowest VP).

This latter situation, referred to as latency optimization, is illustrated in FIG. 2b, and is further described below.

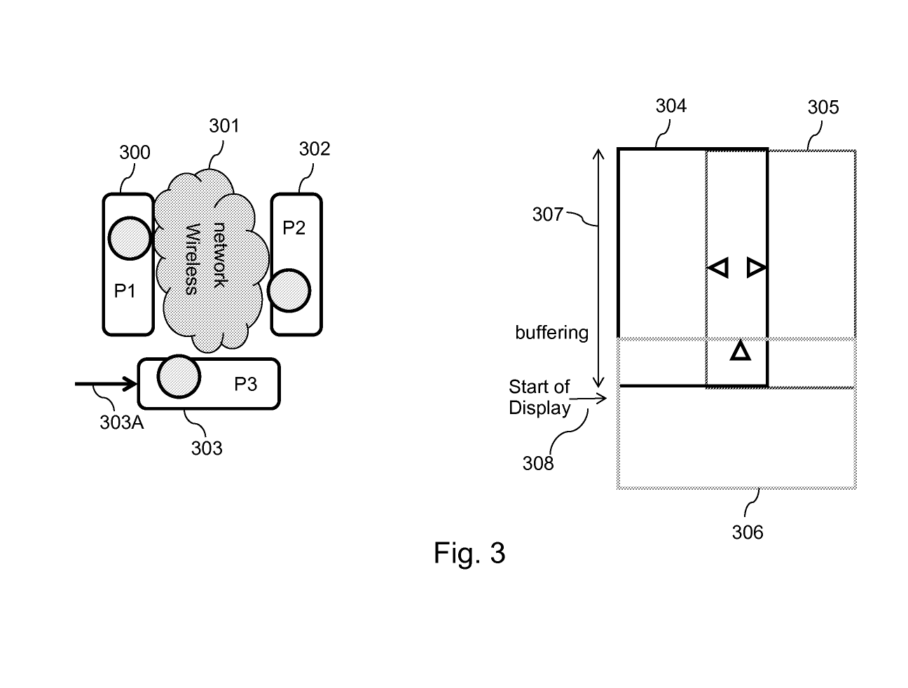

FIG. 3 illustrates a multi-projection system configuration according to an embodiment of the current invention allowing such a latency optimization. Video projectors 300, 302 and 303 are shown in the figure and are capable of receiving input data via a wireless network 301 from a source device. In this illustration, the video projectors 300 and 302 are slave projectors. Video projector 303 is the master projector, receiving data input 303A, which is able to manage the cutting of a global source frame into sub-frames and to distribute these sub-frames to the corresponding video projectors 300 and 302 through a wireless network 301. Video projector 300 is in portrait orientation, and displays sub-frame 304. Video projector 302 is in portrait orientation, and displays sub-frame 305. Video projector 303 is in upright landscape orientation, and displays sub-frame 306. Video projectors 300 and 302 need to receive all data corresponding to their frame sub-frame before being able to start display since they have to reorder the received data according to their orientations. Video projector 303 is capable of starting display as soon as it receives data. Thus data needs to be stored until last pixel data included in sub-frame 304 and 305 are received from video source. A threshold, referred to as “start of display” 308 is then set at a corresponding line number of the global frame. The duration between the start of a global frame and the reach of the “start of display” threshold for this global frame is referred as “display delay”. During this “display delay” interval, video data needs to be stored. Storage is effected by means of a buffer, the buffering time required in relation to the global frame 304 being indicated in FIG. 3 as 307.

FIG. 2b illustrates an example of this “display delay”, i.e. latency. Video source is following Vsync signal 210, while all video projectors (master and slaves) are following Vsync signal 211. Vsync signals 210 and 211 have the same period (one frame duration), but the delay between an occurrence of source Vsync 210 and the following occurrence of video projector's Vsync 211 is reduced in accordance with the “start of display” threshold, and corresponds to a ‘display_delay’ or latency 212. It follows that the start of display of a frame can take place earlier than in the conventional display technique of FIG. 2a.

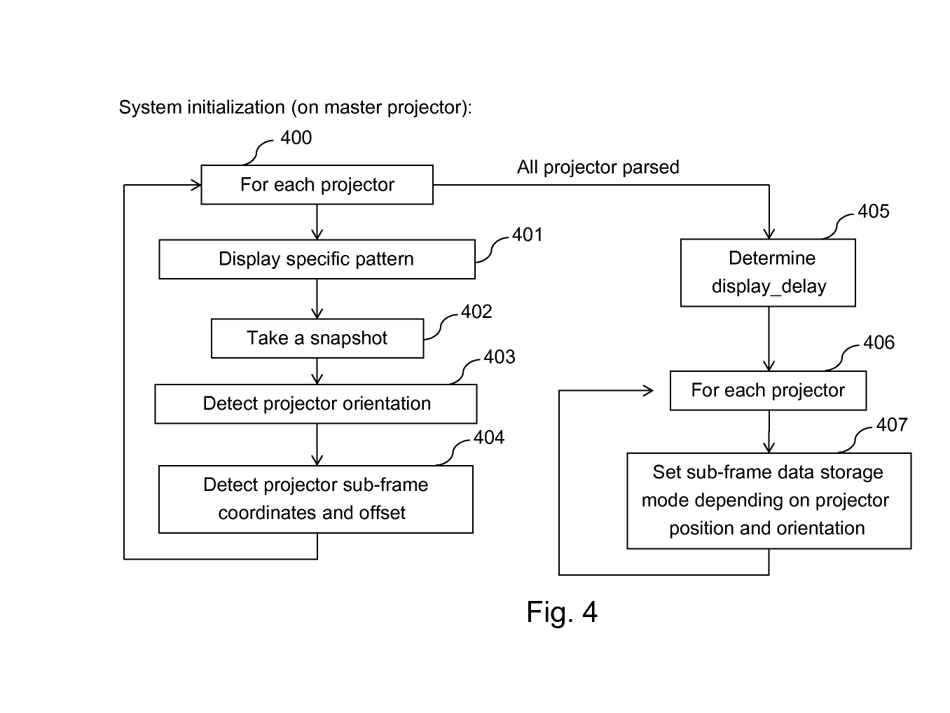

FIG. 4 represents a method of system initialization according to an embodiment of the current invention, which is implemented by means of one of the video projectors, preferably the master video projector.

The method begins by following steps 400 to 404, which are run for each video projector present in the system, including master video projector. These steps comprise:
for each projector 400
display specific pattern 401
take a snapshot 402
detect projector orientation 403
detect projector sub-frame coordinates and offset 404

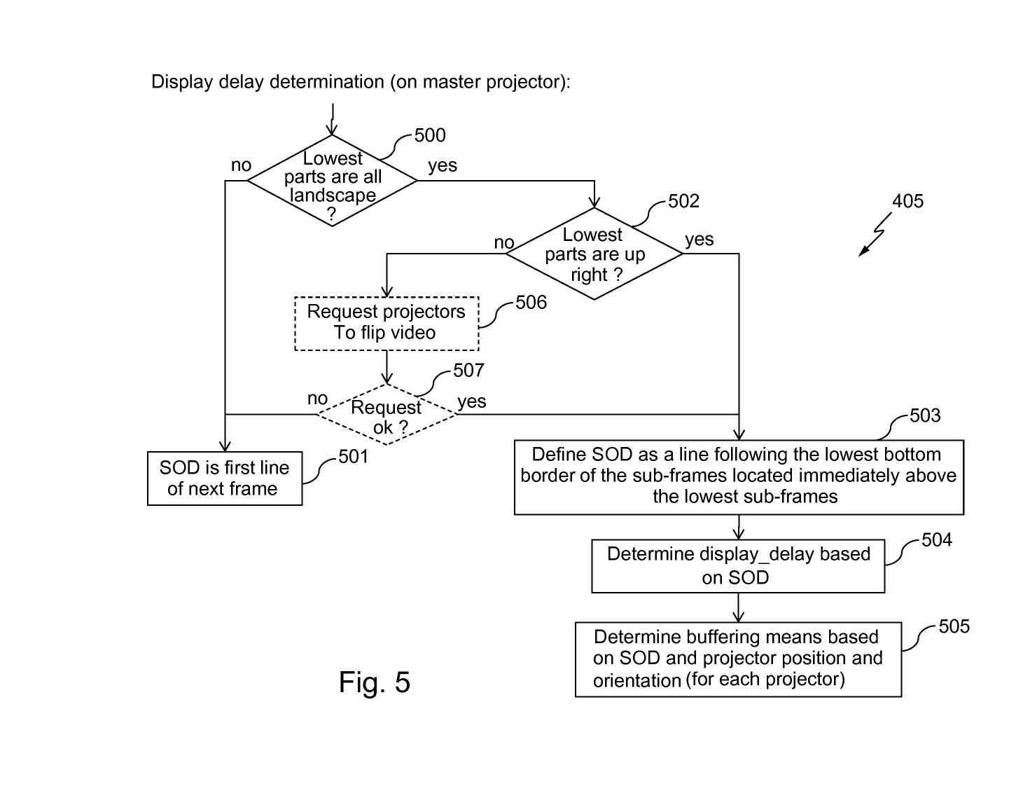

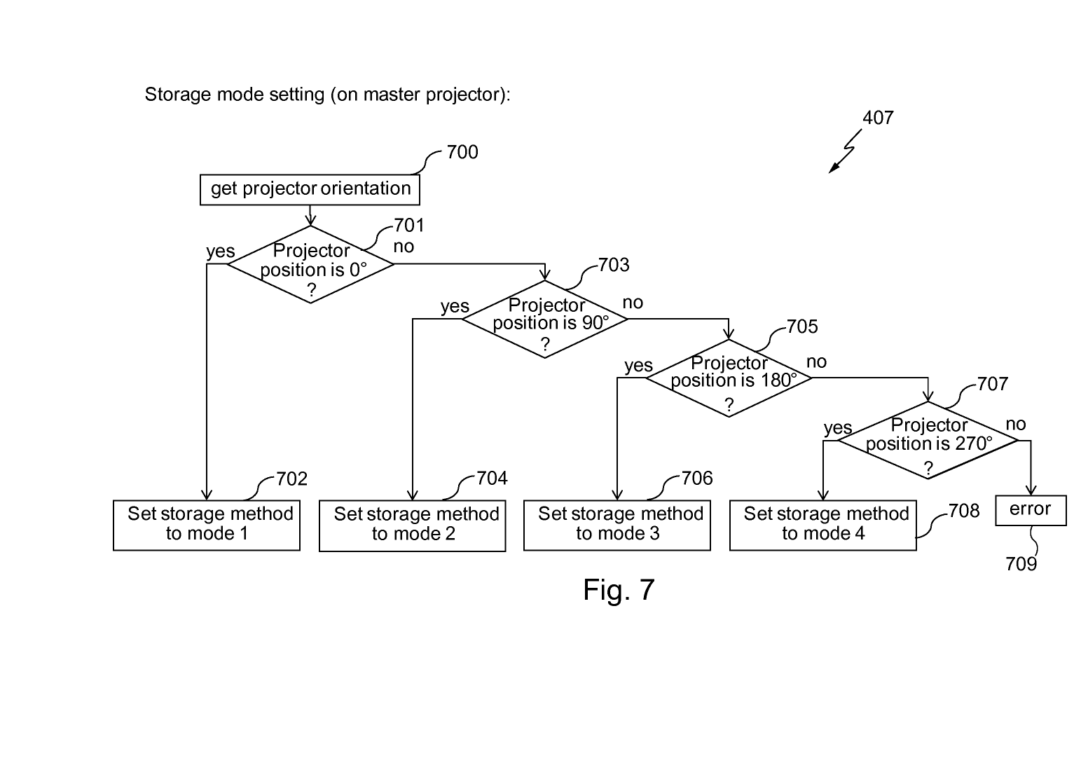

During step, 401, the video projector is arranged to display a specific pattern which facilitates determination of the video projector orientation, for instance an arrow. While this pattern is being displayed, a snapshot of the global screen is taken 402 by means of a digital camera here connected to the master video projector. During steps 403 and 404 the snapshot is used to determine the projector orientation and the coordinates of the sub-frame area displayed by the video projector (the coordinates being defined relative to the global display area). Many techniques have been described in the prior art to implement this system of coordination, thus it is not described further here. Once steps 400 to 404 have been effected for each video projector present in the system, the display_delay value (as defined above) is determined 405. The display_delay is based on position and orientation information, previously determined. This display_delay value determination is detailed further in FIG. 5. Finally, for each video projector 406, storage mode to be used to buffer video data corresponding to the frame sub-frame to be displayed by the video projector is determined: step 407 set sub-frame data storage mode depending on projector position and orientation. This step is further detailed with reference to FIG. 4 and FIG. 7.

FIG. 5 represents a method of display_delay determination according to an embodiment of the current invention, which is implemented here by means of the master video projector. This step is an embodiment of step 405, discussed previously. The determination of the display_delay value relates to the video projector orientations. During step 500, the lowest sub-frame orientation is checked: lowest parts are all landscape? This step is applied to all sub-frames containing a piece of the bottom edge of the global display area. Should at least one of those lowest sub-frames be in portrait orientation, the start of display (SOD) threshold is fixed at the first line of the next global frame in step 501 (i.e. latency is a full global frame duration). Should all of those lowest sub-frames be in landscape orientation, it is checked (step 502: lowest parts are upright?) whether they are all up-right, upright being defined as the top side of the projected image corresponding to the video projector top side.

In the affirmative, the SOD threshold is defined as a (pixel) line following the lowest bottom border of the sub-frames located immediately above the lowest sub-frames 503.

In an alternative embodiment, if sub-frames located immediately above the lowest sub-frames are all in landscape orientation, the SOD threshold is the first (pixel) line of the lowest sub-frame.

Then a display_delay value is determined based on the SOD threshold. Step 504: determine display_delay based on SOD. Indeed, the display_delay can be defined as the delay between the Vsync signal corresponding to the beginning of the current frame and a Hsync signal marking the beginning of the line corresponding to the SOD threshold. As the period and resolution of the frame are known, the display_delay (in seconds) can be obtained by:

display_delay=(number of lines in top vertical blanking+active line number of SOD threshold)/(number of frames per second)

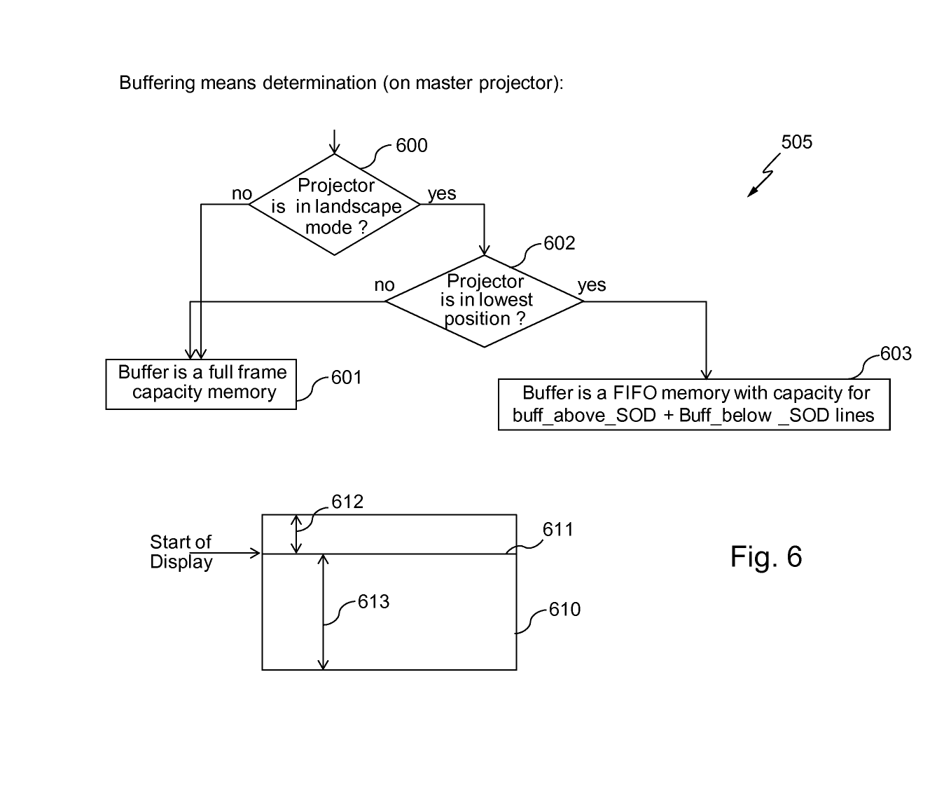

Finally, buffering means to store data to be displayed by each video projector is determined (in step 505: determine buffering means based on SOD and projector position and orientation (for each projector)). More details are provided with reference to FIG. 6.

If step 502 returns a negative, i.e. if at least one (lowest) video projector is upside-down, an optional request 506 may be sent to the upside-down video projector, to flip the video to be displayed (so that this video would be displayed up right). If all upside-down video projectors confirm they have the ability to process such a flip (request OK ? 507), the display_delay value can be determined from step 503, previously described, with steps 504 and 505 following sequentially. If the video projectors do not have the ability to flip the image, the display_delay value is determined by step 501.

FIG. 6 represents a method of storage mode setting according to an embodiment of the current invention, which is here implemented by means of the master video projector.

This step is an embodiment of step 505, discussed previously.

Video data provided by the video source has to be buffered, e.g. by the master video projector, for a time period equivalent to the display_delay previously determined. FIG. 6 details how corresponding buffering means are determined for the video projectors, based on video projector position and SOD. This process is repeated for each video projector in the system. First it is determined if the projector is in landscape mode 600. If yes, it is then determined if the projector is in the lowest position (of the global frame) 602.

If the video projector is in portrait mode, or in landscape mode but not in the bottom of the global display (i.e. does not display parts of the global frame bottom edge), the sub-frame to be displayed by the video projector needs to be fully stored (step 601: buffer is a full frame capacity memory), because all data constituting this sub-frame will be received by the master video projector before SOD threshold has been reached. A memory twice the size of the sub-frame data is required. Usually such a memory is of a “ping pong” type, indicating data corresponding to a sub-frame are stored in a first half of the memory while data corresponding to the previous sub-frame are read from the second half of the memory.

FIG. 6 further comprises a schematic drawing of a sub-frame 610. If the video projector, to which the sub-frame is assigned, has a landscape mode setting and is associated with the bottom of the global frame, lines indicated by arrow 612 located before the line corresponding to SOD threshold 611 (and with the remaining lines of the sub-frame indicated by arrow 613) are stored according to step 601. These lines 612 will be delivered by the video source before the display process starts. The number of these lines 612 is determined by:

buff_above_{—}SOD=SOD_offset−offset of sub-frame first line

(where SOD_offset is the offset of the SOD threshold in number of lines; offsets are defined with reference to the global frame first line).

Moreover, all the video projectors have the same frame rate as the video source, but individual video projector vertical resolution is in some cases lower than video source resolution. This means data will be delivered by video source faster than they will be transmitted to video projectors (same frame rate, but fewer lines to deliver). Thus, some extra buffer capacity is needed to store this data. The number of lines to be stored in this extra buffer is calculated by:

Buff_below_{—}SOD=(src_{—}vres−SOD_offset)*(1−(VP_{—}vres/src_{—}vres))

where src_vres is the vertical resolution of the video source frame (global frame) and VP_vres is the vertical resolution of the video projector.

Data corresponding to the top of the sub-part is read (in order to be transferred to the video projector) while data corresponding to the bottom of the sub-part is written, and thus memory such as a First In First Out (FIFO) memory type is needed. Step 603 indicates the buffer choice: buffer is a FIFO memory with capacity for buff_above_SOD+Buff_below_SOD. The memory size is arranged so that the memory can accommodate at least buff_above_SOD+Buff_below_SOD lines.

FIG. 7 illustrates a method of storage mode setting according to an embodiment of the invention, which is implemented here by means of the master video projector. This step is an embodiment of step 407, discussed previously.

Video projectors have to fill their LCD matrix with video data line by line. But if a video projector is in portrait position, a line of the global frame sub-frame it has to display becomes a column in the video projector LCD matrix. Thus, sub-frame video data have to be rotated according to video projector orientation before being transmitted to the video projector. This rotation process is a reordering of the sub-frame pixel data. In the present invention, this pixel data reordering is done before storage in the master video projector, so that data can be transmitted to the video projector in the same order as they are read from the buffering memory. Once the storage means capacity has been defined, it is time to determine in which order data has to be stored, depending on the orientation of the video projector that will display those data.

This process is implemented according to the method provided in FIG. 7, which is applicable to each video projector in the system. First the projector orientation is obtained 700. If the angle between the horizontal and the horizontal axis of the video projector is 0° 701 (i.e. the video projector is in landscape orientation, and is up-right) no reordering is needed, so storage mode is set to “mode 1” (step 702). Data are stored in memory in the same order as it is received (i.e. first line first pixel data is stored in the first memory address).

If the angle between the horizontal, and the horizontal axis of the video projector is 90° 703 (video projector is in portrait orientation, and its right side on the top), a reordering is needed, so the storage mode is set to “mode 2” (step 704). Data are stored in memory so that the sub-frame is rotated 90° (i.e. first line first column pixel data is stored in the memory address corresponding to last line first column pixel, first line second column pixel data is stored in the memory address corresponding to last but one line, first column pixel, and so on).

If the angle between the horizontal, and the horizontal axis of the video projector is 180° 705 (video projector is in landscape orientation, upside-down), a reordering is needed, so storage mode is set to “mode 3” (step 706). Data are stored in memory so that frame sub-part is rotated 180° (i.e. first lire first column pixel data is stored in the memory address corresponding to last line last column pixel, first line second column pixel data is stored in the memory address corresponding to last line, last but one column pixel, and so on).

If the angle between the horizontal, and the horizontal axis of the video projector is 270° 707 (video projector is in portrait orientation, and its right side on the bottom), a reordering is needed, so storage mode is set to “mode 4” (step 708). Data are stored in memory so that frame sub-part is rotated 270° (ie. first line first column pixel data is stored in the memory address corresponding to first line last column pixel, first line second column pixel data is stored in the memory address corresponding to second line, first column pixel, and so on).

Other angle values are not allowed, so in such a case the method ends with error in step 709.

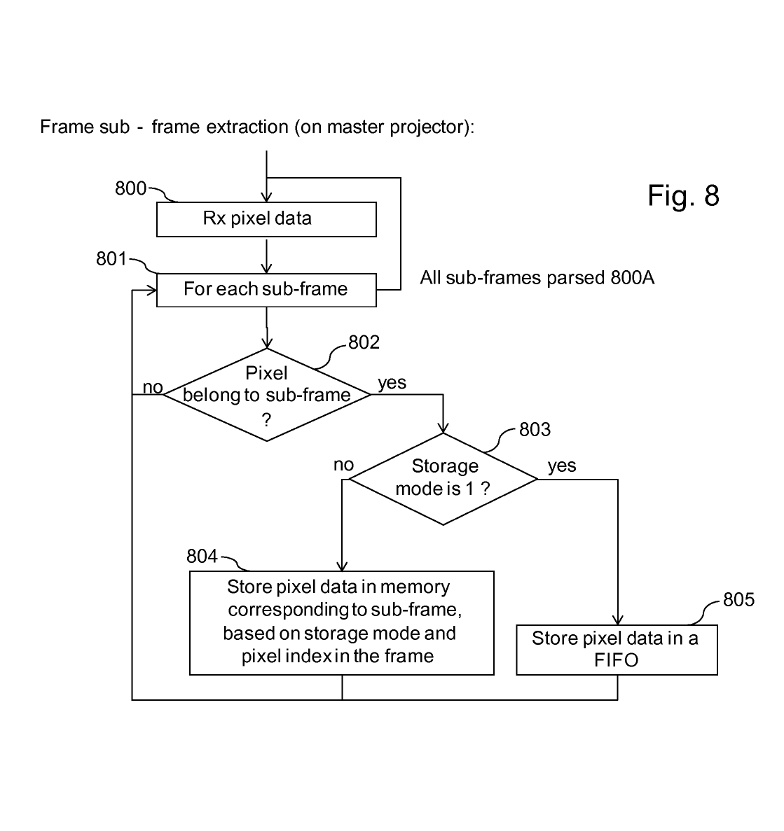

FIG. 8 illustrates frame sub-frame extraction, according to the present invention and implemented here on the master projector. The method comprises the treatment of pixel data arriving from the video source and the processing implemented in order to store the data in the buffering memories. This process comprises the partitioning of the global frame into sub-part, as pixel data are stored on the fly in buffering means based on their belonging to a particular sub-part.

When a pixel data is received (step 800: Rx pixel data), a loop is followed, parsing all global frame sub-frames 800A. For each sub-frame 801, it is checked if the pixel belongs to the sub-frame (step 802). This check is done by comparing pixel coordinates in the global frame with sub-frame vertical and horizontal border offsets determined previously. If the pixel does not belong to the current sub-frame, the loop is reprocessed 801 with the next sub-frame. If the pixel belongs to the current sub-frame, the storage mode of the sub-frame is checked (step 803: storage mode is 1? If storage mode is “mode 1” (up-right video projector, no pixel data reordering), pixel data is stored in the FIFO memory 805 corresponding to the sub-frame. If storage mode is any other mode, pixel data is stored in the “ping pong” memory corresponding to the sub-frame, following the storage mode rule corresponding to this sub-frame. Step 804: store pixel data in memory corresponding to sub-frame based on storage mode and pixel index in the frame.

Once the loop has been processed on all sub-frames, the associated pixel data is processed.

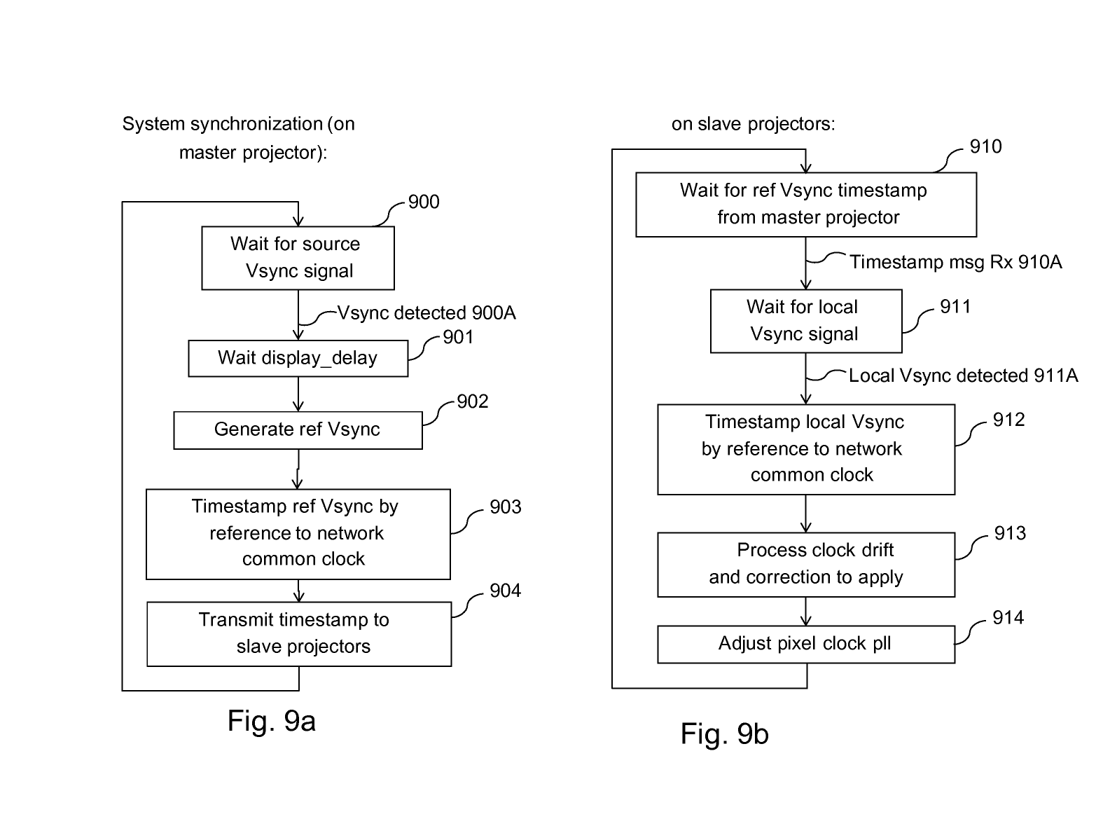

FIG. 9, parts a and b, illustrates methods of system synchronization for the master projector and slave projectors, respectively, according to an embodiment of the current invention.

The figure illustrates the synchronization, used to ensure that all video projectors are synchronized for the display of global frame sub-frames. On all video projectors, pixels are provided to video projector LCD matrix following a clock referred to as the pixel clock. The Vsync signal is generated as the first pixel of a video frame (including blanking pixels) is processed. The pixel clock can be adjusted using “phase lock loops” (PLL) so that the time delimited by two consecutive Vsync occurrences match a targeted frame rate.

In FIG. 9a, the master VP, receiving video data from the video source, is responsible for providing the master/slave Vsync reference (ref Vsync) to other video projectors. This ref Vsync is delayed from the video source Vsync by the duration of display_delay, but it is arranged to follow the video source frame rate. At step 900, the master VP is waiting for Vsync signal (also referred to as a source frame synchronization signal) from the video source. From the moment this source Vsync has been detected 900A, the master VP waits for a period equivalent to the previously determined display_delay 901. Then it generates a ref Vsync occurrence (step 902). In a step not represented on the figure, this ref Vsync is locally used to adjust a local pixel clock PLL, and thus the master local Vsync signal (also referred to as a sub-frame display synchronization signal), which drives the display process of video data corresponding to master VP. This ref Vsync occurrence is time stamped by reference to the network clock (step 903), this network clock being shared by all the video projectors in the system. Finally, the time stamp is transmitted to all slave video projectors in the system (step 904), and the process loops back to step 900.

From the slave video projector perspective in FIG. 9b, the method comprises step 910 (wait for a ref Vsync time stamp from the master VP). Once ref Vsync time stamp is received (step 910A: timestamp msg rx), the slave projector waits for an occurrence of the local Vsync signal (step 911). When detected 911A, this local Vsync occurrence is time stamped by reference to the common network clock in step 912. Based on local and ref Vsync time stamps, a clock drift value is computed (step 913: process clock drift and correction to apply), and used to adjust slave video projectors pixel clock PLL (step 914). The process then loops back to step 910.

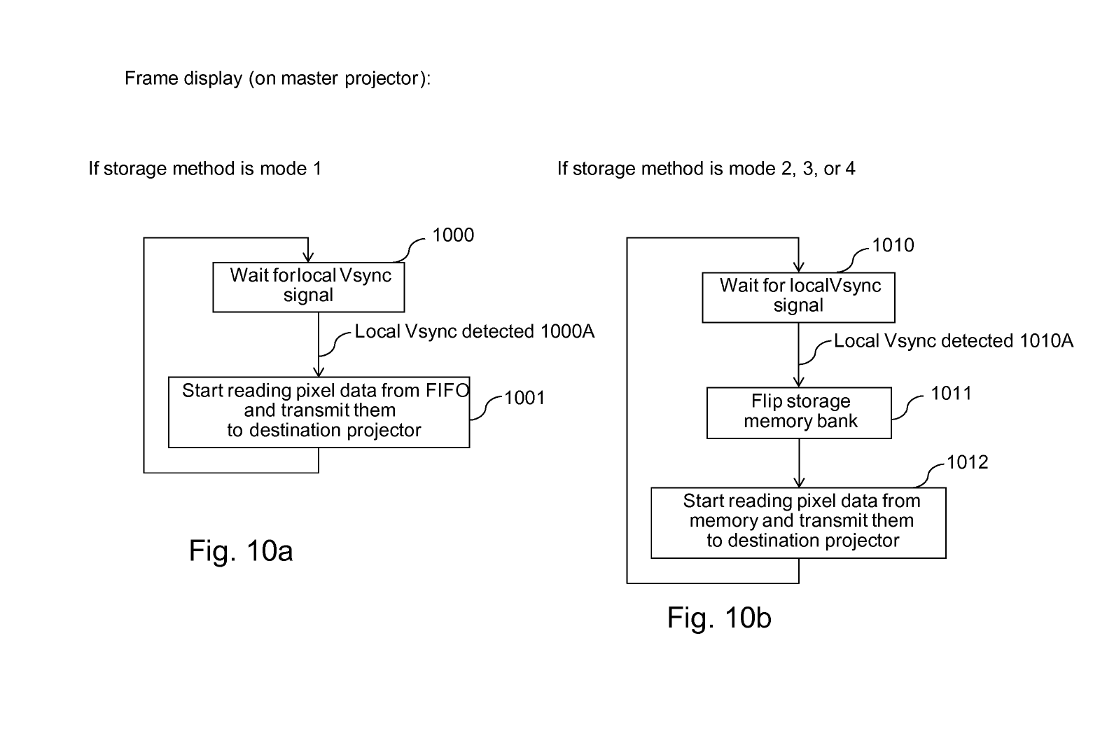

FIG. 10, parts a and b, illustrates frame display according to an embodiment of the current invention as implemented on the master projector. FIG. 10a relates to storage mode equal to mode 1 and FIG. 10b to storage modes 2, 3 and 4.

The master VP reads out data from buffering memories, in order to transmit it to slave video projectors and to its own display sub-frame. FIG. 10a focuses on the FIFO memory case, used if storage “mode 1” has been chosen for a VP. Step 1000 waits for local (or display) Vsync signal occurrence. Once this local Vsync occurrence is detected 1000A, pixel data are read out from the FIFO memory and transmitted to the destination projector 1001. This provision to the master VP display means follows the local pixel clock, if data has to be displayed by the master VP. Alternatively, the data are transmitted to a slave video projector, through e.g. a wireless network adapter. In this latter case, depending on the communication protocols run on the wireless network, pixel data might be regrouped into packets before transmission. Such technics are well known, and are not further described here.

FIG. 10b illustrates the “ping pong” memory case, used if storage mode other than “mode 1” has been chosen for a video projector. Step 1010 illustrates the wait for the local Vsync signal occurrence. Once this local Vsync occurrence is detected 1010A, the memory bank of the “ping pong” memory that was used to read data is switched to write mode, so that pixel data corresponding to the next frame will be stored in this bank; and the memory bank of the “ping pong” memory that was used to write data is switched to read mode, so that pixel data corresponding to the frame to be now displayed will be read from this bank (step 1011: flip memory storage bank). Then, pixel data are read out from the read bank of the ping pong memory and either provided to master VP display means, following local pixel clock, if data has to be displayed by the master VP, or transmitted to a slave VP, through the wireless network adapter. (This is represented in the figure by step 1012: start reading pixel data from memory and transmit them to destination projector). In this latter case, depending on the communication protocols run on the wireless network, pixel data might be regrouped into packets before transmission. Such technics are well known, and are not further described here.

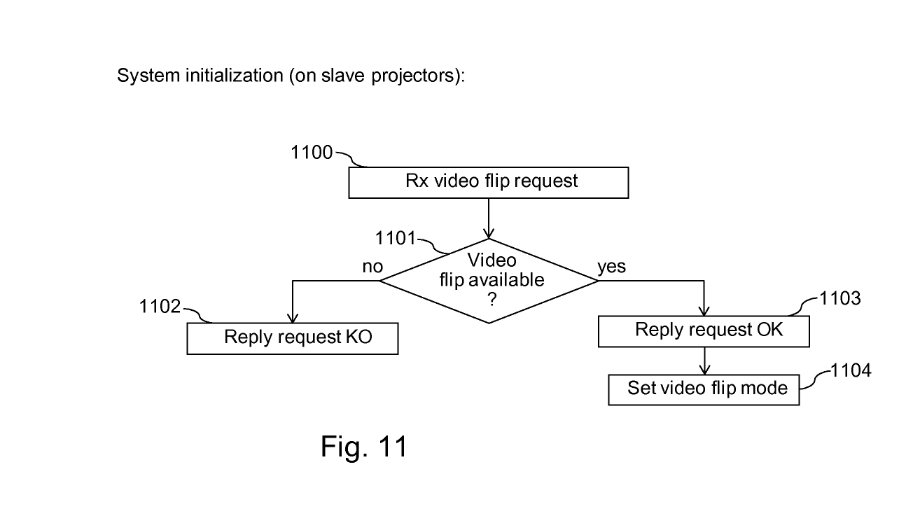

FIG. 11 illustrates an optional method according to an embodiment of the current invention implemented on a slave video projector if it receives a flip request from the master VP. If a video flip request is received 1100, each video projector checks if it has the requested flipping capability 1101. Such functionality is usually present on a video projector in order to allow it to be fixed e.g. on a ceiling in an upside down orientation. In the negative, the video projector returns a negative response to master VP request (step 1102: reply request KO). In the affirmative, the video projector returns an affirmative response to master VP request (step 1103: reply request OK), and set itself to process requested video flip (step 1104: set video flip mode).

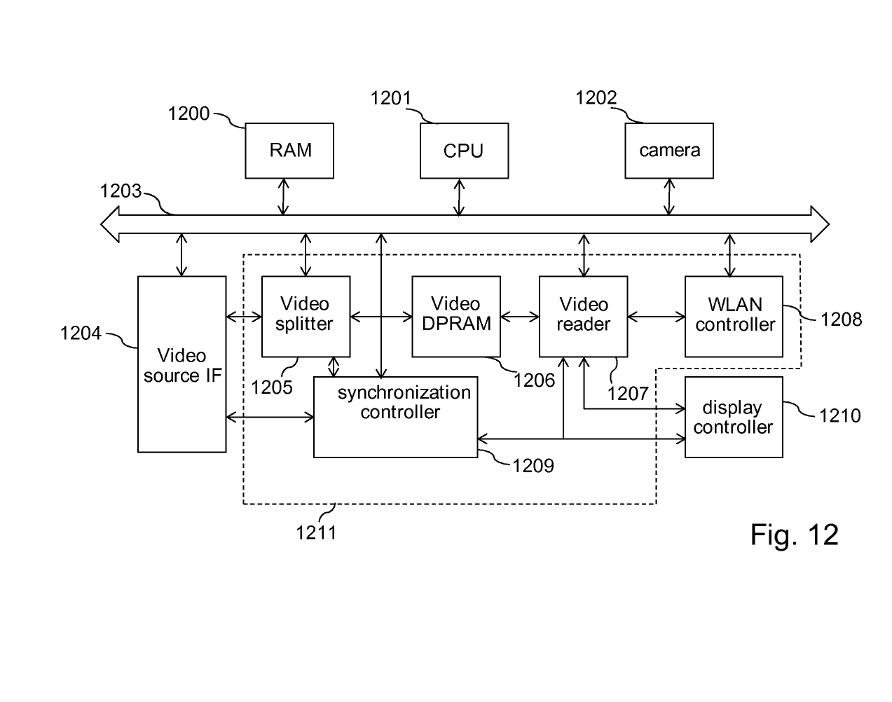

FIG. 12 illustrates a schematic functional block diagram of a video projector capable of implementing an embodiment of the current invention.

A processor, e.g. CPU 1201, is present in order to manage most of the configuration tasks, and implement several methods, such as those described in relation to FIGS. 4, 5, 6, and 7. Those methods generate configuration values which can be set in corresponding functional blocks by means of the processor interconnection bus 1203. All blocks requiring configuration are linked to this bus 1203. A processor random access memory (RAM) 1200 is present to support processor CPU 1201, storing program instructions and data handled by the processor. A camera 1202 is also present, in order to process the system calibration and initialization steps, as previously described.

A video source interface (IF) module 1204 receives the video data and synchronization information from the video source (not shown). For example, the video source interface can be an HDMI adapter. This video source IF outputs the video data (not shown) to a video splitter module 1205, and also outputs synchronization signals to the synchronization controller 1209. The synchronization controller 1209 is responsible for generating the local and ref Vsync signals (i.e. the display frame synchronization signals), and the pixel clock signal, according to methods as presented in FIG. 9. The video splitter 1205 is in charge of reordering and storing video data delivered by the source into the correct memory buffer, according to the method illustrated in FIG. 8. Those memory buffers are implemented in a dual Port RAM (video DPRAM) 1206. This DPRAM can be accessed simultaneously though two ports. A first port is used to write data from video splitter 1205, and the other is used by a video reader module 1207 to read video data from the memory buffers. The video reader module 1207 reads out video data from storing buffers, and provides it either to a wireless local area network (WLAN) controller 1208, or to a local display controller 1210, depending on the video data destination. This video reader module 1207 implements the method defined in relation to FIG. 10.

Modules comprised in the area delimited by box 1211 are modules which have been added to a classical video projector device, in order to implement an embodiment of the invention. In an alternative embodiment of the invention, a part or the totality of the modules included in area 1211 can be integrated in a different device such as the video source device.

1. A method of transmitting a source frame into a video display system comprising a plurality of projectors, the video display system further arranged to produce a projected image from the source frame, each projector arranged to display a sub-frame of the projected image, the method, comprising the steps of:
determining a position and/or an orientation for each projector;
calculating a display delay representative of a delay between reception of a source frame synchronization signal and a sub-frame display synchronization signal, dependent on at least one of the positions and the orientations, such that display of the projected image begins before at least one projector has received an associated complete sub-frame;
applying the display delay between the source frame synchronization signal and a sub-frame display synchronization signal, and;
synchronizing projectors sub-frame display synchronization signals with the sub-frame display synchronization signal.

2. The method as claimed in claim 1 wherein the plurality of projectors comprises a master projector and a plurality of slave projectors, the master projector being arranged to implement the steps of the method.

3. The method as claimed in claim 1, further comprising the step of:
adapting a buffering for each projector according to the position and the orientation for each projector, and according to the display delay.

4. The method as claimed in claim 3, wherein the buffering comprises
FIFO for a landscape up-right projector;
and, Ping-Pong full frame memory for any other orientation.

5. The method as claimed in claim 1, further comprising the step of:
requesting a projector to flip the display of its associated sub-frame if the orientation is determined as upside-down.

6. The method as claimed in claim 1, further comprising the step of:
minimizing the display delay.

7. The method as claimed in claim 2, further comprising the step of:
receiving of the source frame by the master projector.

8. The method as claimed in claim 2, further comprising the step of:
distributing sub-frames to the slave projectors for display by the master projector.

9. A method of operating a video display system comprising a plurality of projectors, the video display system further arranged to cooperate with a video source to produce a projected image from a source frame, each projector arranged to display a sub-frame of the projected image comprising lines, the method comprising the steps of:
checking for a landscape orientation, for each of the projectors associated with a bottom border of the projected image;
defining a start-of-display parameter as a line associated with the sub-frames comprising the bottom border of the projected image, the line comprising the line immediately following the lowest horizontal overlapping area between said sub-frames and sub-frames located immediately above, and;
determining a display delay for the projected image based on the start-of-display parameter, such that display of the projected image is suspended until data associated with the sub-frames of the bottom border of the projected image in advance of the start-of-display parameter are placed in a buffer.

10. A method of operating a video display system comprising a plurality of projectors, the video display system arranged to cooperate with a video source to produce a projected image from a source frame, each projector arranged to display a sub-frame of the projected image comprising lines, the method comprising the steps of:
checking for a landscape orientation, for each of the projectors associated with a bottom border of the projected image;
checking for a landscape orientation, for each of the projectors associated with a portion of the projected image located immediately above the bottom border of the projected image;
defining a start-of-display parameter as a first pixel line of the lowest sub-frame if the sub-frames located immediately above the lowest sub-frames are all in landscape orientation, and;
determining a display delay for the projected image based on the start-of-display parameter, such that display of the projected image is suspended until data associated with the lowest sub-frames above the bottom border and above the start-of-display parameter are available from the video source.

11. The method as claimed in claim 9, wherein the plurality of projectors comprises a master projector and a plurality of slave projectors, the master projector being arranged to implement the steps of the method.

12. The method of operating a video display system as claimed in claim 9, further comprising the step of:
checking for an upright positioning, for each of the projectors associated with the bottom border of the projected image.

13. The method of operating a video display system as claimed in claim 9 further comprising the step of:
determining buffering means based on the start-of-display parameter, for each of the projectors associated with a bottom border of the projected image.

14. A non-transitory computer-readable storage medium for storing a computer program for transmitting a source frame into a video display system comprising a plurality of projectors, the video display system further arranged to produce a projected image from the source frame, each projector arranged to display a sub-frame of the projected image, wherein the program for transmitting can be loaded into a computer system and comprises instructions executable by a processor for carrying the steps of:
determining a position and/or an orientation for each projector;
calculating a display delay representative of a delay between reception of a source frame synchronization signal and a sub-frame display synchronization signal, dependent on at least one of the positions and the orientations, such that display of the projected image begins before at least one projector has received an associated complete sub-frame;
applying the display delay between the source frame synchronization signal and a sub-frame display synchronization signal, and;
synchronizing projectors sub-frame display synchronization signals with the sub-frame display synchronization signal.

15. A non-transitory computer-readable storage medium for storing a computer program for operating a video display system comprising a plurality of projectors, the video display system further arranged to cooperate with a video source to produce a projected image from a source frame, each projector arranged to display a sub-frame of the projected image comprising lines, wherein the program for operating can be loaded into a computer system and comprises instructions executable by a processor for carrying the steps of:
checking for a landscape orientation, for each of the projectors associated with a bottom border of the projected image;
defining a start-of-display parameter as a line associated with the sub-frames comprising the bottom border of the projected image, the line comprising the line immediately following the lowest horizontal overlapping area between said sub-frames and sub-frames located immediately above, and;
determining a display delay for the projected image based on the start-of-display parameter, such that display of the projected image is suspended until data associated with the sub-frames of the bottom border of the projected image in advance of the start-of-display parameter are placed in a buffer.

16. A device for transmitting a source frame into a video display system comprising a plurality of projectors, the video display system further arranged to produce a projected image from the source frame, each projector arranged to display a sub-frame of the projected image, the device comprising:
means for determining a position and/or an orientation for each projector;
means for calculating a display delay representative of a delay between reception of a source frame synchronization signal and a sub-frame display synchronization signal, dependent on at least one of the positions and the orientations, such that display of the projected image begins before at least one slave projector has received an associated complete sub-frame;
means for applying the display delay between the source frame synchronization signal and a master projector sub-frame synchronization signal, and;
means for synchronizing slave projectors sub-frame display synchronization signals with the master projector sub-frame synchronization signal.

17. The device as claimed in claim 16 further comprising:
means for adapting a buffering for each projector according to the position and the orientation for each projector, and according to the display delay.

18. The device as claimed in claim 16 further comprising:
means for requesting a projector to flip the display of its associated sub-frame if the orientation is determined as upside-down.

19. The device as claimed in claim 16 further comprising:
means for minimizing the display delay.

20. A device for operating a video display system comprising a plurality of projectors, the video display system further arranged to cooperate with a video source to produce a projected image from a source frame, each projector arranged to display a sub-frame of the projected image comprising lines, the method comprising the steps of:
means for checking for a landscape orientation, for each of the projectors associated with a bottom border of the projected image;
means for defining a start-of-display parameter as a line associated with the sub-frames comprising the bottom border of the projected image, the line comprising the line immediately following the lowest horizontal overlapping area between said sub-frames and sub-frames located immediately above, and;
means for determining a display delay for the projected image based on the start-of-display parameter, such that display of the projected image is suspended until data associated with the sub-frames of the bottom border of the projected image in advance of the start-of-display parameter are placed in a buffer.

21. A device for operating a video display system comprising a plurality of projectors, the video display system arranged to cooperate with a video source to produce a projected image from a source frame, each projector arranged to display a sub-frame of the projected image comprising lines, the method comprising the steps of:
means for checking for a landscape orientation, for each of the projectors associated with a bottom border of the projected image;
means for checking for a landscape orientation, for each of the projectors associated with a portion of the projected image located immediately above the bottom border of the projected image;
means for defining a start-of-display parameter as a first pixel line of the lowest sub-frame if the sub-frames located immediately above the lowest sub-frames are all in landscape orientation, and;
means for determining a display delay for the projected image based on the start-of-display parameter, such that display of the projected image is suspended until data associated with the lowest sub-frames above the bottom border and above the start-of-display parameter are available from the video source.

22. The device as claimed in claim 16, wherein the plurality of projectors comprises a master projector and a plurality of slave projectors.
